(19) United States
(12) Patent Application Publication
(10) Pub. No.: US 2004/0199462 A1
(43) Pub. Date: Oct. 7, 2004

(54) Fraud control method and system for network transactions

(76) Inventor: Ed Starrs, Pebble Beach, CA (US)

Correspondence Address: SAWYER LAW GROUP LLP, P.O. Box 51418, Palo Alto, CA, 94303, US

(21) Appl. No.: 10/405,410

(22) Filed: Apr. 2, 2003

(51) Int. Cl. G06F 17/60

(52) U.S. Cl. 705/39

(57) ABSTRACT

A method for providing secure payment over a network, includes: receiving a request from a consumer for payment of an amount from a consumer account with a secure payment entity to a merchant; determining by the secure payment entity that a blended risk score on the consumer is of an acceptable level; debiting the amount from the consumer account by the secure payment entity; and crediting the amount to a merchant account with the secure payment entity by the secure payment entity, where the secure payment entity guarantees the credit of the amount to the merchant account. In this manner, consumers are able to purchase goods and services from merchants while minimizing the merchants' losses from charge backs and fraud.

### FIELD OF THE INVENTION

The present invention relates to network financial transactions and more particularly to fraud control in network financial transactions.

### BACKGROUND OF THE INVENTION

Financial transactions between consumers and merchants through a network, such as the Internet, have and will continue to gain prominence in the global economy. Although such transactions have many benefits to both consumers and merchants, the loss incurred by merchants due to charge backs and fraud are considerably larger than for transactions between consumers and brick-and-mortar merchants.

Typically, the consumer accesses a merchant's web site to purchase goods and/or services. The consumer provides information concerning him/herself and a credit card number to pay for the goods/services. The merchant submits the charge to the credit card company and completes the transaction with the consumer once the credit card company authorizes the charge. This type of financial transaction directly between the consumer and the merchant is called “straight-through processing”.

However, when the consumer refutes (or disputes) the charge, a “charge back” occurs on the consumer's credit card account, and payment to the merchant is reversed. Thus, not only does the merchant lose a sale, but it also must absorb the cost of the transaction. The same is true when the order is fraudulent. Although third party entities exist to facilitate transactions between consumers and merchants, the transaction itself is still a straight-through process, with the merchant liable for charge backs and loss due to fraud.

Accordingly, there exists a need for an improved fraud control method and system for network transactions. The fraud control method and system should enable consumers to purchase goods and services from merchants through the Internet while minimizing the merchants' losses from charge backs and fraud. The present invention addresses such a need.

### SUMMARY OF THE INVENTION

A method for providing secure payment over a network, includes: receiving a request from a consumer for payment of an amount from a consumer account with a secure payment entity to a merchant; determining by the secure payment entity that a blended risk score on the consumer is of an acceptable level; debiting the amount from the consumer account by the secure payment entity; and crediting the amount to a merchant account with the secure payment entity by the secure payment entity, where the secure payment entity guarantees the credit of the amount to the merchant account. In this manner, consumers are able to purchase goods and services from merchants while minimizing the merchants' losses from charge backs and fraud.

### BRIEF DESCRIPTION OF THE FIGURES

FIG. 1 illustrates a preferred embodiment of a fraud control system in accordance with the present invention.

FIG. 2 is a flowchart illustrating the functioning of the fraud control system in accordance with the preferred embodiment of the present invention.

FIG. 3 is a flowchart illustrating in more detail the functioning of the fraud control system in accordance with the preferred embodiment of the present invention.

FIG. 4 is a flowchart illustrating in more detail the obtaining of the blended risk score by the security check software of the fraud control system in accordance with the present invention.

FIG. 5 is a block diagram illustrating the functioning a hotel booking model using the fraud control system in accordance with the present invention.

### DETAILED DESCRIPTION

The present invention provides an improved fraud control method and system for network transactions. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

In the fraud control method and system in accordance with the present invention, a consumer and a merchant each has an account with a secure payment entity. The secure payment entity performs two separate transactions, one to fund the consumer's account and one to consummate a sale between the consumer and the merchant. The secure payment entity performs a security check in both transactions by obtaining a blended risk score for the consumer and determining if it is of an acceptable level. Based on this security check, the secure payment entity guarantees the credit to the merchant's account against a charge back from the consumer and against fraud. In this manner, consumers are able to purchase goods and services from merchants while minimizing the merchants' losses from charge backs and fraud.

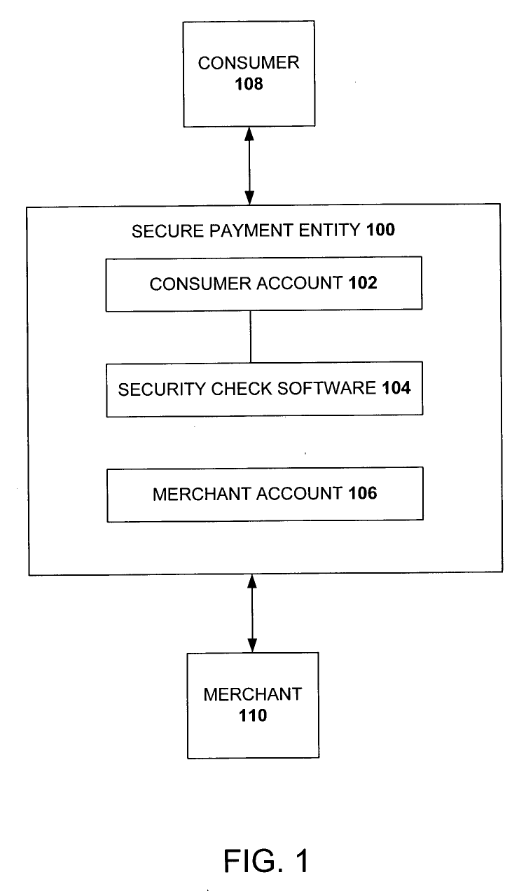

To more particularly describe the features of the present invention, please refer to FIGS. 1 through 5 in conjunction with the discussion below.

FIG. 1 illustrates a preferred embodiment of a fraud control system in accordance with the present invention. The system comprises a secure payment entity 100 that in turn comprises security check software 104. The services of the secure payment entity 100 are sold to merchants who accept the secure payment entity currency as a form of payment from consumers. The secure payment entity 100 maintains a consumer account 102 for a consumer 108 and a merchant account 106 for the merchant 110. The secure payment entity 100 uses the security check software 104 to perform fraud screening when the consumer 108 requests to fund the consumer account 102 or requests a purchase. Requests that pass the fraud screening are then serviced.

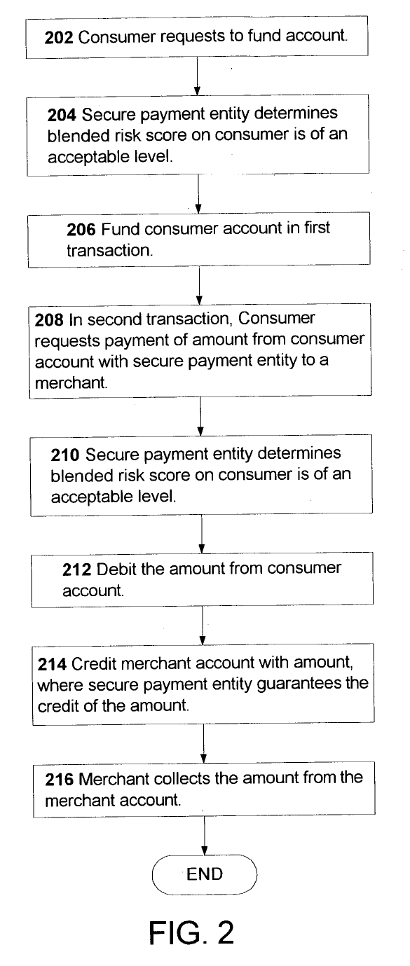

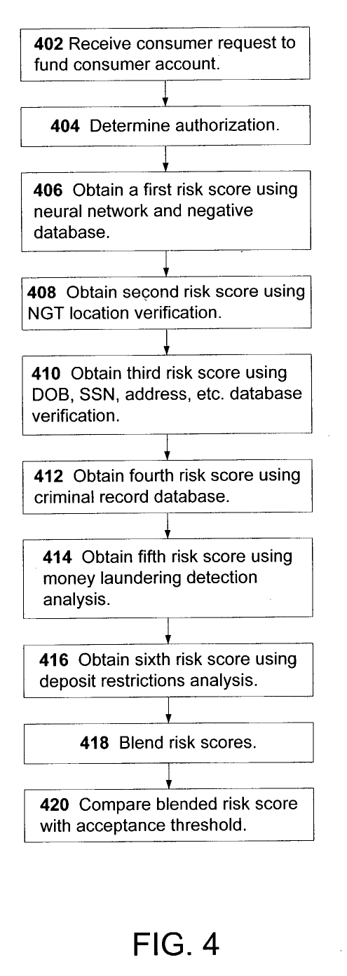

FIG. 2 is a flowchart illustrating the functioning of the fraud control system in accordance with the preferred embodiment of the present invention. The consumer 108 first requests to fund the consumer account 102 with the secure payment entity 100, via step 202. The consumer 108 can use a credit card, a bank account, or some other means of providing the funds. The secure payment entity 100 performs fraud screening using the security check software 104 prior to funding the consumer account 102. In the preferred embodiment, the security check software 104 configures a blended risk score based on a plurality of factors, via step 204. The blended risk score and the factors are further described below with FIG. 4. If the consumer's blended risk score is of an acceptable level, then the consumer account 102 is funded, via step 206, in a first transaction.

In a second transaction, the consumer 108 requests a purchase of goods or services from the merchant 110 by requesting that an amount of the secure payment entity currency be paid from the consumer account 102 to the merchant 110, via step 208. The security check software 104 then performs another security check and determines that the blended risk score on the consumer 108 is of an acceptable level, via step 210. In the preferred embodiment, the blended risk score is obtained each time the consumer 108 requests to fund the consumer account 102 or requests a purchase. The secure payment entity 100 then debits the amount from the consumer account 102, via step 212. Then, the secure payment entity 100 credits the amount to the merchant account 106, via step 214. The merchant 110 can then collect the amount from its merchant account 106, via step 216.

Importantly, the secure payment entity 100 performs the fraud screening in such a manner that it guarantees the credit of the amount to the merchant account 106. Thus, if the consumer 108 charges back the amount or if the purchase by the consumer 108 is fraudulent, the secure payment entity 100 absorbs the corresponding losses. This reduces the losses incurred by the merchant 110. Such a guarantee is particularly useful to merchants who sell goods or services over the Internet.

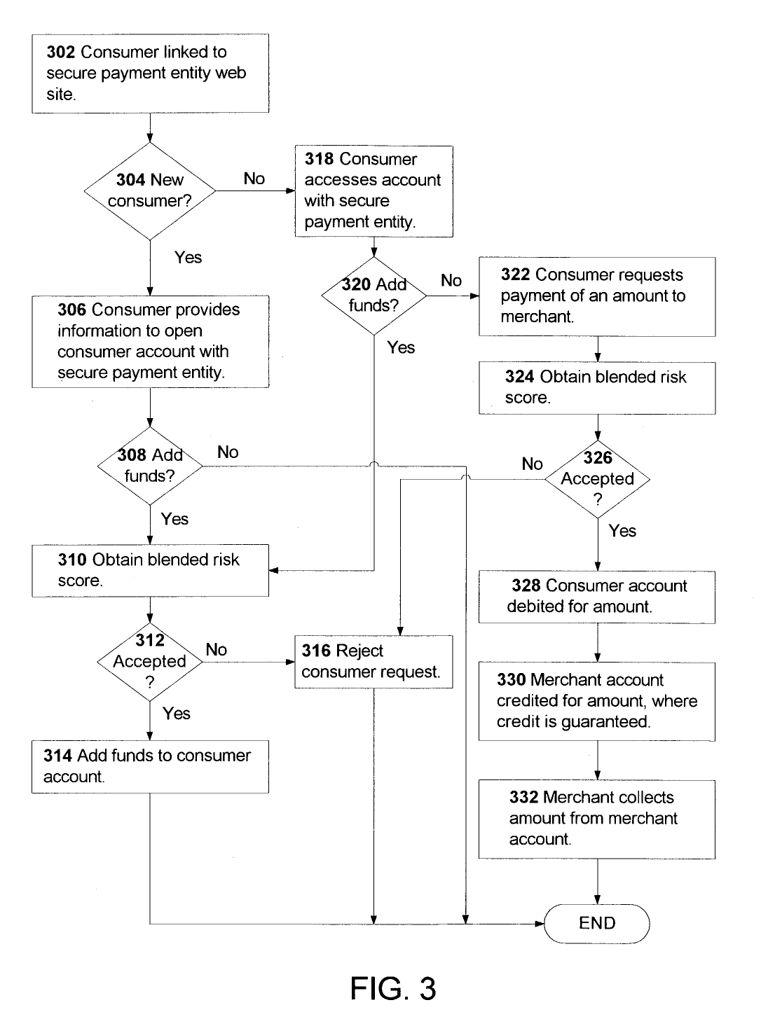

FIG. 3 is a flowchart illustrating in more detail the functioning of the fraud control system in accordance with the preferred embodiment of the present invention. Assume that the consumer 108 visits a merchant's web site and decides to purchase goods or services from the merchant 110. The consumer 108 is linked to the secure payment entity web site, via step 302. On the web site, the consumer 108 is provided an opportunity to pay using secure payment entity currency. Assume that the consumer 108 chooses this option. If the consumer 108 is a new consumer, via step 304, i.e., the consumer 108 does not have an existing account with the secure payment entity 100, then the consumer 108 can open and request to fund a consumer account 102 with the secure payment entity 100 by providing the required information, via step 306, such as name, address, social security number, and credit card number. The consumer 108 selects the option to fund the consumer account 102, via step 308. The security check software 104 then performs fraud screening and obtains a blended risk score on the consumer 108, via step 310. If the blended risk score is determined to be of an acceptable level, via step 312, then the funds are added to the consumer account 102, via step 314. If not, then the consumer's request to fund the consumer account 102 is rejected, via step 316.

If the consumer 108 has an existing consumer account 102, then the consumer 108 accesses the account 102 with the secure payment entity 100, via step 318. In the preferred embodiment, the consumer enters his/her ID and password to gain access. Other methods of authentication may be used. The consumer 108 can request that addition funds be added to the consumer account 102, via step 320. A blended risk score is then obtained on the consumer 108, via step 310. If the blended risk score is determined to be of an acceptable level, via step 312, then the funds are added to the consumer account 102, via step 314. If not, then the funding of the consumer account 102 is rejected, via step 316. The funds in the consumer account 102 are considered to be secure payment entity currency.

The consumer 108 can request that an amount of the secure payment entity currency from the consumer account 102 be paid to the merchant 110, via step 322, for goods or services. The security check software 104 then obtains a blended risk score on the consumer 108, via step 324. If the blended risk score is not determined to be of an acceptable level, via step 326, then the consumer's purchase request is rejected, via step 316. If the blended risk score is determined to be of an acceptable level, via step 326, then the secure payment entity 100 debits the consumer account 102 of the amount, via step 328. The secure payment entity 100 then credits the merchant account 106 of the amount, via step 330. In doing so, the secure payment entity 100 guarantees the credit of the amount to the merchant account 106. Thus, if the consumer 108 later charges back the amount or if the purchase is fraudulent, the secure payment entity 100 absorbs the losses. Regardless of a charge back or fraud, the merchant 110 is able to collect the amount from its merchant account 106, via step 332.

FIG. 4 is a flowchart illustrating in more detail the obtaining of the blended risk score by the security check software 104 of the fraud control system in accordance with the present invention. When a request to fund the consumer account 102 is received from the consumer 108, via step 402, the security check software 104 first determines if the consumer 108 has authorization to fund the account 102 with the consumer's credit card or bank account, via step 404. If the consumer 108 has authorization, then a first risk score is obtained by examining various information from a neural network and negative databases, via step 406. For example, the consumer's credit history can be examined for the number of charge backs and other patterns. If the consumer has a history of a high number of charge backs, then the consumer may be considered a high risk. If the consumer has never made a transaction online but has made several in the last few hours, this pattern may indicate possible fraud. Similarly, a change in charge patterns also may indicate possible fraud. Consumer profiles from certain databases are also checked, such as law enforcement lists, terrorist lists, state gambling blacklists, etc. Using this information, the first risk score is determined.

A second risk score is obtained by the security check software 104 using Network Geo-location Technology (NGT), via step 408. The NGT accurately determines the physical location of the consumer's 108 hardware used to connect to the Internet. The second risk score is obtained by comparing the physical location with the reported location and IP address of the consumer 108 to identify mismatches.

A third risk score is obtained by the security check software 104 by verifying the consumer's information with public records and privately maintained databases, such as date of birth, social security number, address, etc., via step 410. Significant changes in the consumer's information is monitored, such as name changes, address changes, changes in death status and potential criminal activity.

A fourth risk score is obtained using information from the criminal record database, via step 412.

A fifth risk score is obtained from money laundering detection analysis, via step 414. Potential money laundering activity are identified. For example, if the fund requested by the consumer 108 is part of several similar requests of similar size, then this may indicate possible money laundering. The secure payment entity 100 may also impose account restrictions that make it very difficult to perpetuate money laundering using the system.

A sixth risk score is obtained using a deposit restrictions analysis, via step 416. The secure payment entity 100 can imposed account restrictions on the consumer account 108. For example, restrictions concerning amount, time, payment method and region (state or country) can be imposed.

The risk scores are then weighted and blended to obtain the blended risk score, via step 418. The blended risk score represents the degree of risk associated with the consumer request. Requests are accepted or rejected by comparing the blended risk score with an acceptance threshold, via step 420.

In the preferred embodiment, the security check performed prior to funding a consumer account, via step 310, is more robust than the security check performed prior to consummating a purchase, via step 324. For example, in obtaining the blended risk score in step 324, the fifth and sixth risk scores are used, while in obtaining the blended risk score in step 310, all six risk scores are used.

Although the preferred embodiment is described above with the six risk scores, one of ordinary skill in the art will understand that other types of risk scores can be used to obtain the blended risk score without departing from the spirit and scope of the present invention.

In the preferred embodiment, a consumer request may be flagged for manual review if the blended risk score is within a certain range of the acceptance threshold. By performing manual review of selective requests, losses due to fraud can be further reduced.

Although the present invention has been described above in the context of purchases by a consumer of a merchant's goods or services, the system in accordance with the present invention can be used in other contexts as well. For example, the system may be used within a hotel booking model.

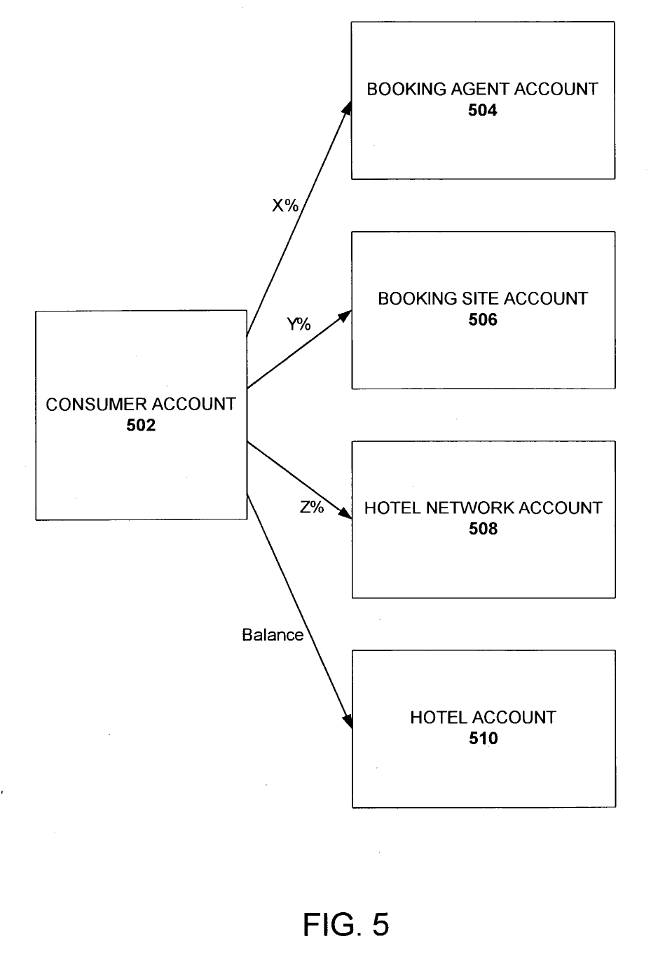

FIG. 5 is a block diagram illustrating the functioning a hotel booking model using the fraud control system in accordance with the present invention. Typically, several parties are involved in a booking of a hotel reservation by a consumer. For example, a booking agent, a booking web site, a hotel, and a hotel reservation network can all share in the proceeds from a consumer's reservation. However, hotel reservations historically suffer from a high percentage of cancellations and charge backs. In addition, payment of commissions to the various parties are often delayed or not paid at all. This results in loss for the parties involved.

To minimize the loss, the consumer can book the hotel reservation using the secure payment entity currency in his/her consumer account 502. The parties involved in the booking each also has an account 504-510 with the secure payment entity 100. The consumer's booking is then scrutinized using the security check software 104 in the manner described above. If the blended risk score is above the acceptance threshold, then the cost for the reservation is debited from the consumer account 502. After the appropriate time, such as after the period for cancellation ends, the secure payment entity 100 then credits the booking agent account 504 with the booking agent's commission (X% of the cost), credits the booking site account 506 with the booking site's commission (Y% of the cost), credits the hotel reservation network account 508 with the hotel reservation network's commission (Z% of the cost), and credits the hotel account 510 with the hotel's share (the balance of the cost). Each of the credits is guaranteed by the secure payment entity 100. In this manner, loss to the various parties in a hotel booking is minimized.

An improved fraud control method and system has been disclosed. In this system, a consumer and a merchant each has an account with a secure payment entity. The secure payment entity performs two separate transactions, one to debit the consumer's account and one to credit the merchant's account, to consummate a sale between the consumer and the merchant. The secure payment entity guarantees the credit to the merchant's account against a charge back from the consumer and against fraud. In this manner, consumers are able to purchase goods and services from merchants while minimizing the merchants' losses from charge backs and fraud.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing secure payment over a network, comprising the steps of:
(a) receiving a request from a consumer for payment of an amount from a consumer account with a secure payment entity to a merchant;
(b) determining by the secure payment entity that a blended risk score on the consumer is of an acceptable level;
(c) debiting the amount from the consumer account by the secure payment entity; and
(d) crediting the amount to a merchant account with the secure payment entity by the secure payment entity, wherein the secure payment entity guarantees the credit of the amount to the merchant account.

2. The method of claim 1, wherein the receiving step (a) comprises:
(a1) receiving information from the consumer to open the consumer account with the secure payment entity;
(a2) receiving a request to fund the consumer account from the consumer;
(a3) obtaining a second blended risk score on the consumer;
(a4) comparing the second blended risk score with an acceptance threshold level; and
(a5) funding the consumer account if the second blended risk score is of the acceptable level.

3. The method of claim 2, wherein the receiving step (a) further comprises:
(a6) rejecting the request to fund the consumer account if the second blended risk score
is not of the acceptable level.

4. The method of claim 1, wherein the determining step (b) comprises:
(b1) obtaining a plurality of risk scores on the consumer;
(b2) weighing and blending the plurality of risk scores to obtain the blended risk score; and
(b2) comparing the blended risk score with an acceptance threshold level.

5. The method of claim 4, wherein the obtaining step (b1) comprises:
(b1i) obtaining a first risk score using a neural network and negative databases.

6. The method of claim 4, wherein the obtaining step (b1) comprises:
(b1i) obtaining a second risk score using Network Geo-location Technology location verification.

7. The method of claim 4, wherein the obtaining step (b1) comprises:
(b1i) obtaining a third risk score using database verification of information concerning the consumer.

8. The method of claim 4, wherein the obtaining step (b1) comprises:
(b1i) obtaining a fourth risk score using a criminal records database.

9. The method of claim 4, wherein the obtaining step (b1) comprises:
(b1i) obtaining a fifth risk score using a money laundering detection analysis.

10. The method of claim 4, wherein the obtaining step (b1) comprises:
(b1i) obtaining sixth risk score using a deposit restrictions analysis.

11. The method of claim 4, wherein the determining step (b) further comprises:
(b4) rejecting the request for payment of the amount if the blended risk score is not of the acceptance level.

12. The method of claim 1, further comprising:
(e) receiving a request from the merchant to collect the amount from the merchant account.

13. The method of claim 1, wherein the credit of the amount to the merchant account is guaranteed against a charge back or fraud by the consumer.

14. A secure payment entity, comprising:
a consumer account for a consumer;
a merchant account for a merchant; and
a security check mechanism for obtaining a blended risk score on the consumer when the secure payment entity receives a request from the consumer for payment of an amount from the consumer account to the merchant,
wherein the secure payment entity determines that if the blended risk score is of an acceptable level, then the secure payment entity debits the amount from the consumer account,
wherein if the blended risk score is of an acceptable level, then the secure payment entity credits the amount to the merchant account, wherein the secure payment entity guarantees the credit of the amount to the merchant account.

15. The secure payment entity of claim 14, wherein the security check mechanism further obtains a second blended risk score on the consumer when the secure payment entity receives a request from the consumer to fund the consumer account, wherein if the second blended risk score is of the acceptable level, then the secure payment entity funds the consumer account.

16. A computer readable medium with program instructions for providing secure payment over a network, comprising the instructions for:
(a) receiving a request from a consumer for payment of an amount from a consumer account with a secure payment entity to a merchant;
(b) determining by the secure payment entity that a blended risk score on the consumer is of an acceptable level;
(c) debiting the amount from the consumer account by the secure payment entity; and
(d) crediting the amount to a merchant account with the secure payment entity by the secure payment entity, wherein the secure payment entity guarantees the credit of the amount to the merchant account.
